(19) United States
(12) Patent Application Publication
(10) Pub. No.: US 2003/0196946 A1
(43) Pub. Date: Oct. 23, 2003

(54) Water treatment system using magnetism and far infrared technology

(76) Inventor: Carl M. Denzer, Houston, TX (US)

Correspondence Address: Richard C. Litman, LITMAN LAW OFFICES, LTD., P.O. Box 15035, Arlington, VA, 22215, US

(21) Appl. No.: 10/419,328

(22) Filed: Apr. 21, 2003

Related U.S. Application Data
(60) Provisional application No. 60/374,538, filed on Apr. 23, 2002.

(51) Int. Cl. C02F 1/48

(52) U.S. Cl. 210/223; 210/169; 210/243; 210/259

(57) ABSTRACT

A water treatment system using magnetism and far infrared technology comprising magnets and tubing coated with far infrared ceramic powder which subject water molecules to magnetic fields and far infrared wavelength energy to bend, stretch and disrupt hydrogen bonds and thereby facilitate removal of entangled impurities.

### CROSS-REFERENCE TO RELATED APPLICATION

This application claims the benefit of U.S. Provisional Patent Application Serial No. 60/374,538, filed Apr. 23, 2002.

### BACKGROUND OF THE INVENTION

1. Field of the Invention

The present invention relates to water purification systems, and more particularly, to an aquarium water treatment system incorporating the use of magnetism and far infrared technology.

2. Description of the Related Art

The use of magnetism and far infrared technology in the treatment of water is known. Both magnetism and far infrared technology facilitate removal of impurities from water by affecting atomic bonds within water molecules. Far infrared wavelength energy weakens the ionic bond of atoms and, within water molecules, causes hydrogen bonds to bend or stretch thereby allowing easier removal of entangled impurities. Likewise, magnetic fields act to disrupt hydrogen bonding which also allows for easier removal of impurities.

The prior art includes water treatment devices using magnetism and far infrared technology separately or in arrangements unsuitable for use with an aquarium. For example, U.S. Pat. Nos. 4,210,535 and 4,836,932 to, respectively, Risk and Walsh disclose devices that use magnetism in the treatment of water. However, neither device also incorporates the use of far infrared technology nor is suitable for use with an aquarium.

Additionally, U.S. Pat. No. 5,881,674 to Kim et al. discloses a process for preparing the interior surface of an aquarium with debris-repellent properties. The process involves irradiating the interior surface with far infrared light and thereby creating an electron deficiency on the surface. Because most dirt particles adhere to surfaces by their central positive charge, the electron deficient surface repels such dirt particles. However, although the process prevents dirt particle accumulation on the interior surface of an aquarium, the process does not facilitate removal of impurities from water contained within an aquarium.

Also, U.S. Pat. No. 6,439,207 to Liu discloses “a generator of high oxygen molecule” which incorporates two magnets, infrared granules and oxygen-containing pebbles all contained within a cylinder. Automobile fuel or water is passed through the cylinder to increase oxygen content. Although the device includes magnets and far infrared granules, both the magnets and granules are contained within the cylinder and therefore impede the flow of liquid through the device. Furthermore, the infrared granules are not secured to the inside of the cylinder and thus are subject-to dislocation from the cylinder.

Finally, Japanese Pat. No. JP2211288 to Kiyonori discloses a device for “activating water” in which water or a substance containing water is circulated through magnetic tubing and then collected in a tank containing a radiator that emits far infrared rays. The device, however, does not simultaneously apply magnetism and far infrared technology to water molecules.

Thus, none of the above inventions and patents, taken either singly or in combination, is seen to describe the instant invention as claimed.

### SUMMARY OF THE INVENTION

The water treatment system using magnetism and far infrared technology subjects water molecules to magnetic fields and far infrared wavelength energy to facilitate the removal of impurities from aquarium water by bending, stretching or disrupting hydrogen bonds.

The preferred embodiment of the device is comprised of tubing coated with far infrared ceramic powder, an outer sleeve, two end caps, epoxy and magnets. The tubing runs through the outer sleeve and is held in place by the two end caps. The magnets are secured between the tubing and the outer sleeve by epoxy.

An alternative preferred embodiment is identical to the preferred embodiment except that a coil of electrical wire is used in place of magnets.

A second alternative preferred embodiment of the device is comprised of two discs, several lengths of tubing running between the discs, magnets and epoxy. The inner surface of each length of tubing is coated with far infrared ceramic powder and the magnets are secured inside each tube with epoxy.

Accordingly, it is a principal object of the invention to combine magnetic fields and far infrared technology in a single device that facilitates the removal of impurities from water contained in an aquarium, improves aquarium water clarity, and reduces the frequency of necessary water changes in an aquarium.

It is also an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of the preferred embodiment of a water purification system using magnetism and far infrared technology according to the present invention.

FIG. 2 is an environmental, perspective view of an alternative embodiment of a water purification system using magnetism and far infrared technology according to the present invention.

FIG. 3 is an elevational perspective view of the preferred embodiment of a water purification system using magnetism and far infrared technology according to the present invention.

FIG. 4 is a cross-sectional side view of the preferred embodiment of a water purification system using magnetism and far infrared technology according to the present invention.

FIG. 5 is a cross-sectional front view of the preferred embodiment of a water purification system using magnetism and far infrared technology according to the present invention.

FIG. 6 is a cross-sectional side view of an alternative preferred embodiment of a water purification system using magnetism and far infrared technology according to the present invention in which magnetism is provided by a coil of electrical wire.

FIG. 7 is a elevational perspective view of a second alternative preferred embodiment of a water purification system using magnetism and far infrared technology according to the present invention.

FIG. 8 is a front view of a second alternative preferred embodiment of a water purification system using magnetism and far infrared technology according to the present invention.

FIG. 9 is a fragmented view of a tube from a second alternative preferred embodiment of a water purification system using magnetism and far infrared technology according to the present invention.

FIG. 10 is a cross-sectional view drawn along lines A-A of FIG. 8 of a second alternative preferred embodiment of a water purification system using magnetism and far infrared technology according to the present invention.

Similar reference characters denote corresponding features consistently throughout the attached drawings.

### DETAILED DESCRIPTION OF THE PREFERRED EMBODIMENTS

The present invention is a water treatment system that combines the use of magnetic fields and far infrared technology to facilitate the removal of impurities from water contained in an aquarium. Water processed by the device is subjected to magnetic fields and far infrared wavelengths which weaken or disrupt hydrogen bonding in water molecules and thereby facilitating removal of entangled impurities.

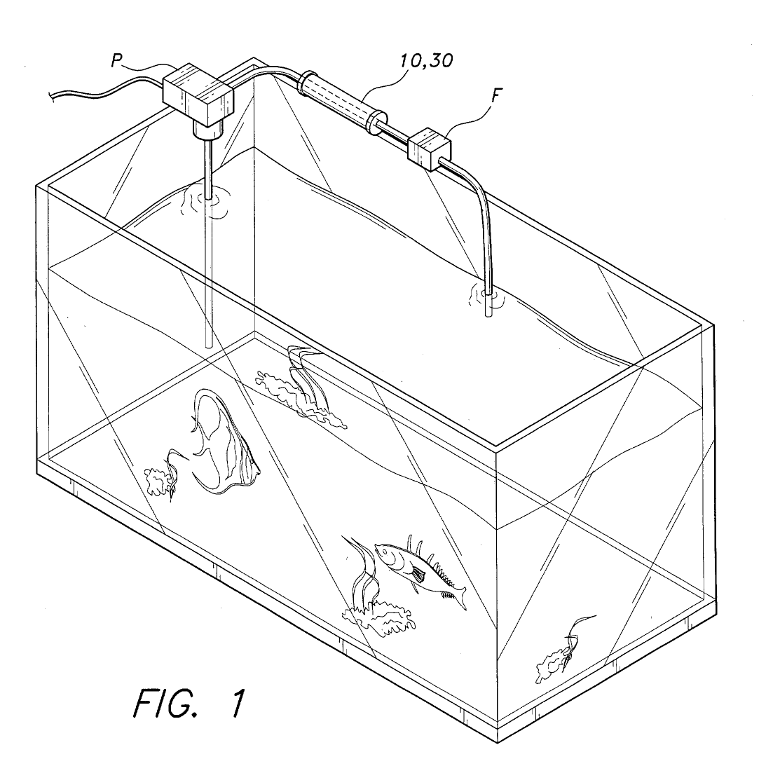

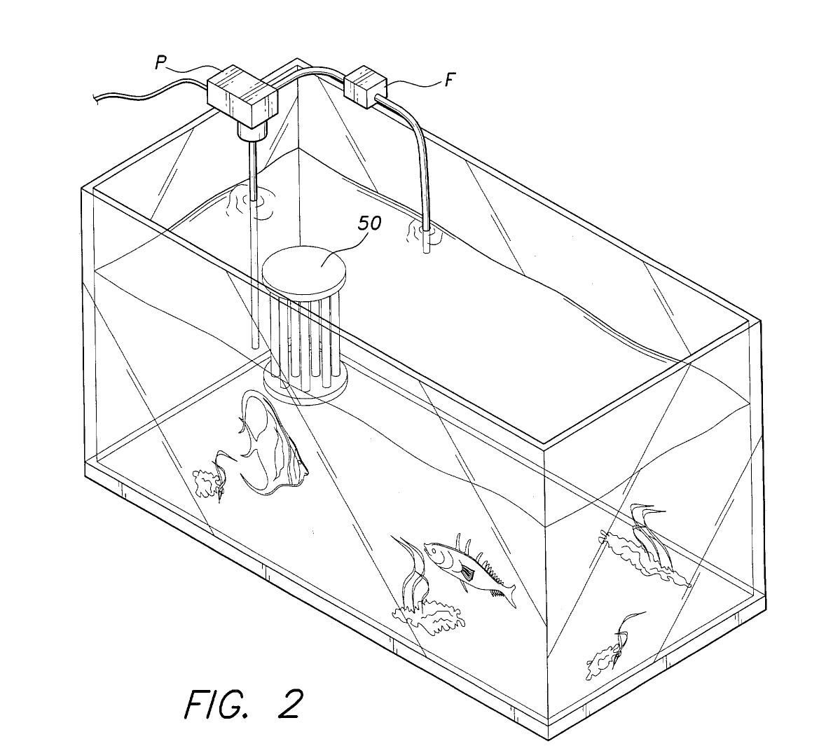

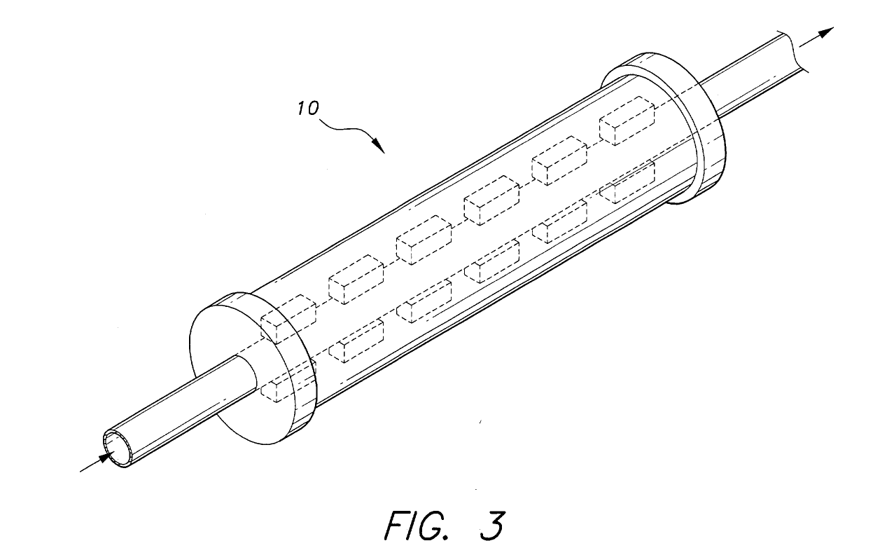

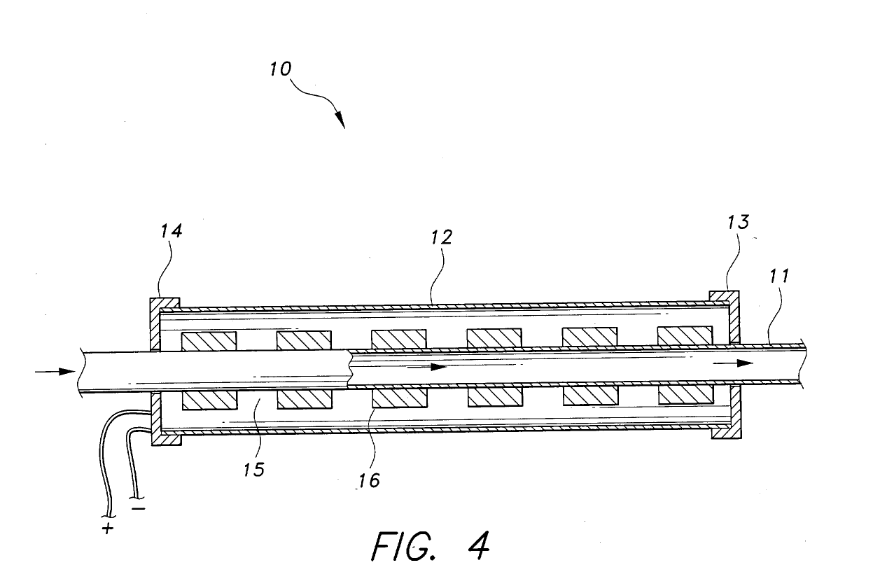

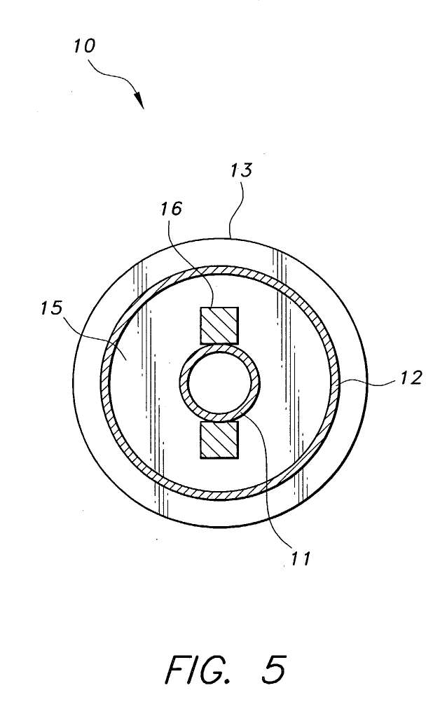

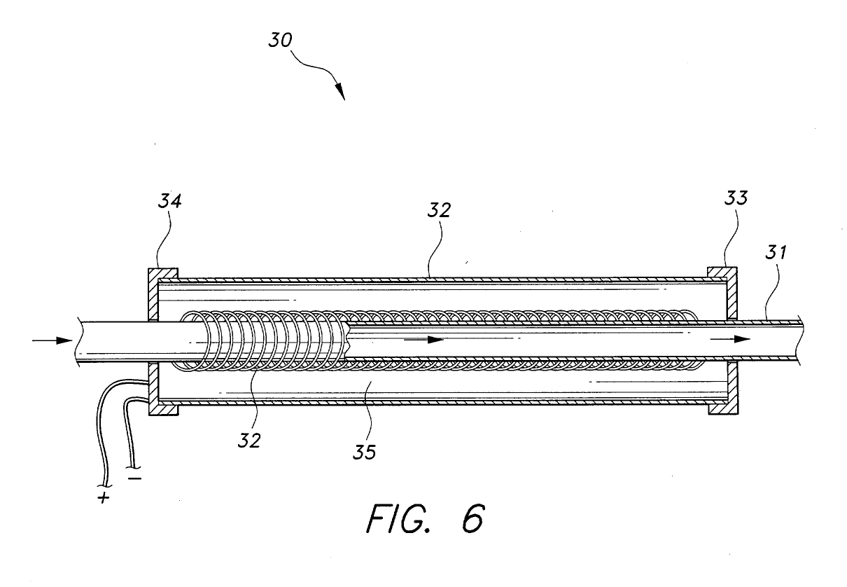

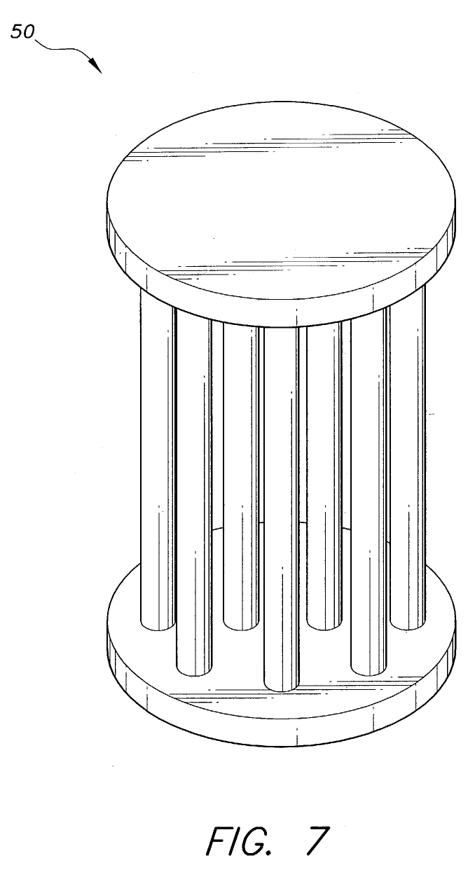

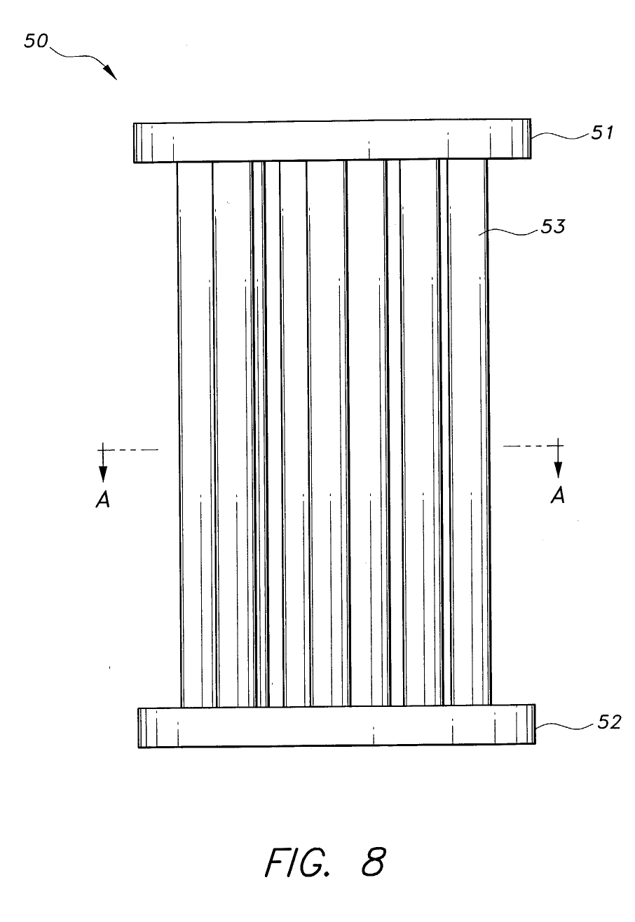

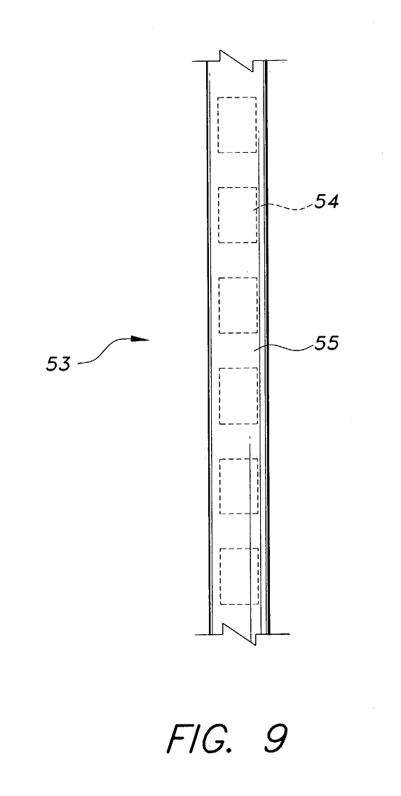

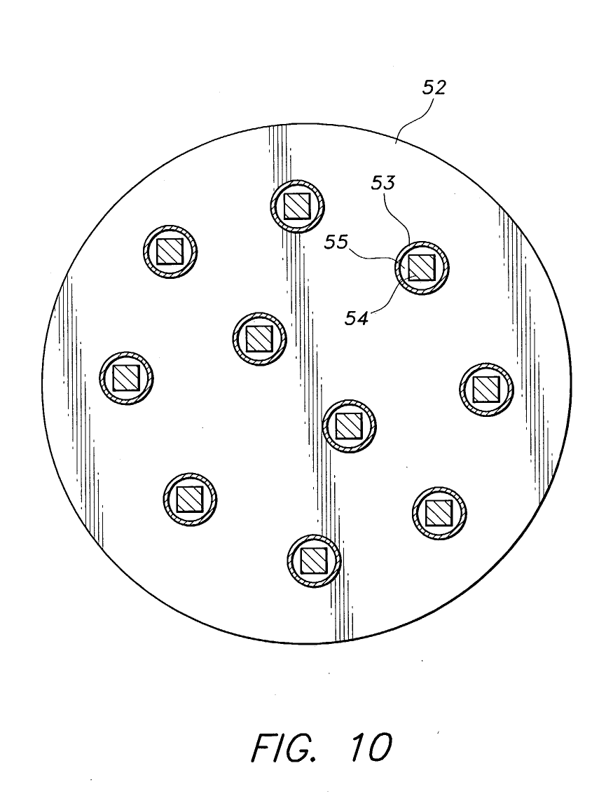

Referring to the drawings, FIGS. 1 and 2 present environmental views of present invention, FIGS. 3 through 5 illustrate the preferred embodiment of the present invention, FIG. 6 shows an alternative preferred embodiment, and FIGS. 7 through 10 depict a second alternative preferred embodiment.

As shown in FIGS. 3 through 5, the preferred embodiment 10 is comprised of a tube 11, an outer sleeve 12, two end caps 13 and 14, a plurality of magnets 16 and epoxy 15. The tube 11 is constructed of an acrylic material that can be penetrated by far infrared wavelength energy and its 11 outer surface is coated with far infrared ceramic powder. The tube 11 runs through the outer sleeve 12. Each end cap 13 and 14 mates with one end of the tube 11 and one end of the outer sleeve 12 to form two watertight seals. Contained within the cavity 15 defined by the outer surface of the tube 11, the two end caps 13 and 14, and the inner surface of the outer sleeve 12, are at least two rows of magnets 16—each row of magnets positioned along the tube 11. The cavity 15 is filled with epoxy which secures the magnets 16 and the coating far infrared ceramic powder in place. Water W passing through the tube 11 is subjected to a magnetic field and far infrared wavelength energy.

An alternative preferred embodiment 30, as shown in FIG. 6, is identical to the preferred embodiment except that the magnetic field is provided by a coil of electrical wire 36. The cavity 35 defined by the outer surface of the tube 31, the two end caps 33 and 34, and the inner surface of the outer sleeve 32 is filled with epoxy which secures the coiled of electrical wire 36 in place.

As shown in FIG. 1, either of the above two embodiments is used to facilitate the removal of impurities from aquarium water by installing the device 10, 30 between the aquarium pump P and the aquarium filter F.

A second alternative preferred embodiment 50, shown in FIGS. 7 through 10, is comprised of two discs 51 and 52, a plurality of tubes 53, a plurality of magnets 54, and epoxy 55. Each of the tubes 53 is constructed of an acrylic material that can be penetrated by far infrared wavelength energy and the inner surface of each tube 53 is coated with far infrared ceramic powder. One end of each tube 53 is secured to the bottom surface of one disc 51 and the other end of each tube 53 is secured to the top surface of the other disc 52. The ends of each tube 53 mate to shallow cavities in each disc 51 and 52 to form watertight seals. A column of magnets 54 is positioned within each tube 53 and each tube is filled with epoxy 55 to secure the magnets 54 and the coating of far infrared ceramic powder in place. Water passing near to or coming in contact with the tubes 53 is subjected to magnetic fields and far infrared wavelength energy. As shown in FIG. 2, the device 50 is used to facilitate the removal of impurities from aquarium water by placing the device 50 near the intake tube of an aquarium pump P.

Although the invention 10, 30 is shown working in conjunction with a standard aquarium filter in FIGS. 1 and 2, it is to be understood that the invention 10, 30 is able to work in conjunction with or be incorporated inside other aquarium devices and equipment including but not limited to a protein skimmer, a foam fractionator, a canister filter, an ultraviolet light sterilizer, an ozonation medium unit, a live sand system, a trickle system, a sump pump, a refugium, a calcium reactor and an aquarium tank.

Further, it is to be understood that the present invention is not limited to the embodiments described above, but encompasses any and all embodiments within the scope of the following claims.

I claim:

1. A water purification system using magnetism and far infrared technology, comprising:
a tube;
means for providing far infrared wavelength energy;
means for providing a magnetic field; and
means for securing both said means for providing far infrared wavelength energy and said means for providing a magnetic field to said tube;
wherein said means for providing a magnetic field and said means for providing far infrared wavelength energy are secured to said tube such that water flowing through said tube is subjected to a magnetic field and to far infrared wavelength energy.

2. The device according to claim 1, further comprising:
an outer sleeve having a first end and a second end;
wherein said tube is positioned within said outer sleeve and wherein said means for providing far infrared wavelength energy and said means for providing a magnetic field are secured between outer surface of said tube and inner surface of said outer sleeve.

3. The device according to claim 2, further comprising:
a first end cap having a cylindrical side and a top with an aperture;
a second end cap having a cylindrical side and a top with an aperture; and
wherein said cylindrical side of said first end cap mates with said first end of said outer sleeve to form a watertight seal and said aperture in said first end cap mates with said tube to form a watertight seal;
wherein said cylindrical side of said second end cap mates with said second end of said outer sleeve to form a watertight seal and said aperture in said second end cap mates with said tube to form a watertight seal; and
wherein means for providing far infrared wavelength energy and means for providing a magnetic field are contained within cavity defined by outer surface of said tube, inner surface of outer sleeve, first end cap and second end cap.

4. The device according to claim 3, wherein:
said means for securing both said means for providing far infrared wavelength energy and said means for providing a magnetic field to said tube is epoxy;

5. The device according to claim 3, wherein:
said means for providing far infrared wavelength energy is far infrared ceramic powder.

6. The device according to claim 3, wherein:
said tube is constructed of an acrylic material capable of penetration by far infrared wavelength energy.

7. The device according to claim 3, wherein:
said means for providing a magnetic field is a plurality of magnets.

8. The device according to claim 3, wherein:
said means for providing a magnetic field is a coil of electrical wire.

9. The device according to claim 3, wherein:
said device operates in conjunction with a second device from the group consisting of a protein skimmer, a foam fractionator, a canister filter, an ultraviolet light sterilizer, an ozonation medium unit, a live sand system, a trickle system, a sump pump, a refugium, a calcium reactor and an aquarium tank.

10. A water purification system using magnetism and far infrared technology, comprising:
a plurality of tubes;
a first disc and a second disc;
means for providing magnetic fields; and
means for providing far infrared wavelength energy;
wherein said plurality of tubes are substantially equal in length and each of said tubes has a first end and a second end;
wherein each of said first disc and said second disc has a plurality of cavities equal in number to said plurality of tubes;
wherein said first end of each of said plurality of tubes mates with a corresponding cavity in said first disc to form a water tight seal;
wherein said second end of each of said plurality of tubes mates with a corresponding cavity in said second disc to form a watertight seal; and
wherein said means for providing magnetic fields and said means for providing far infrared wavelength energy are contained inside each of said plurality tubes such that water in contact with the outer surface of each of said plurality of tubes is subjected to a magnetic field and to far infrared wavelength energy.

11. The device according to claim 10, wherein:
said means for providing far infrared wavelength energy is far infrared ceramic powder.

12. The device according to claim 10, wherein:
each of said plurality of tubes is constructed of an acrylic material capable of penetration by far infrared wavelength energy.

13. The device according to claim 10, wherein:
said means for providing magnetic fields is a plurality of magnets.
